(19) United States
(12) Patent Application Publication
(10) Pub. No.: US 2014/0086815 A1
(43) Pub. Date: Mar. 27, 2014

(54) USE OF SILICON CARBIDE TUBES WITH A FLANGED OR FLARED END

(71) Applicants: Bernd Wehner, Karlstein (DE); Christof Zipper, Rheinfelden (DE); Guido Stochniol, Haltern am See (DE); Ingo Pauli, Schmitten (DE); Norbert Schladerbeck, Kelkheim (DE)

(72) Inventors: Bernd Wehner, Karlstein (DE); Christof Zipper, Rheinfelden (DE); Guido Stochniol, Haltern am See (DE); Ingo Pauli, Schmitten (DE); Norbert Schladerbeck, Kelkheim (DE)

(73) Assignee: EVONIK DEGUSSA GmbH, Essen (DE)

(21) Appl. No.: 14/005,979

(22) PCT Filed: Feb. 28, 2012
(86) PCT No.: PCT/EP2012/053356

§ 371 Date: Dec. 4, 2013

(30) Foreign Application Priority Data
Mar. 25, 2011 (DE) 10 2011 006 111.8
Dec. 14, 2011 (DE) 10 2011 088 532.3

(51) Int. Cl. C01B 33/107

(52) U.S. Cl. CPC C01B 33/1071
USPC 423/342

(57) ABSTRACT

The invention relates to the use of a ceramic tube composed of silicon carbide variants in processes for converting chlorosilanes, wherein the tube has a flange or a flare at one end and is closed at the other end.

The invention relates to the use of silicon carbide tubes which have one flanged or flared end and are closed at the other end in processes for conversion of chlorosilanes.

The different types of ceramic tube known to those skilled in the art, consisting entirely or partly of silicon carbide or in which the silicon carbide is bound in different ways, are abbreviated in the context of the invention to “xSiC tube”. The xSiC tube may be in the form of an “elongated cup-like shaped body”.

Such xSiC tubes may be gas-tight either by virtue of the material itself or by virtue of covering layers formed in the course of firing.

Silicon carbide tubes have long been known in the art. In process technology, for example, tubes of such materials are used for heat exchangers. The tubes end flush with a flat tube cross section. At the transition of the xSiC tube to metal or another material, tightness is achieved with an elastomeric sealing element.

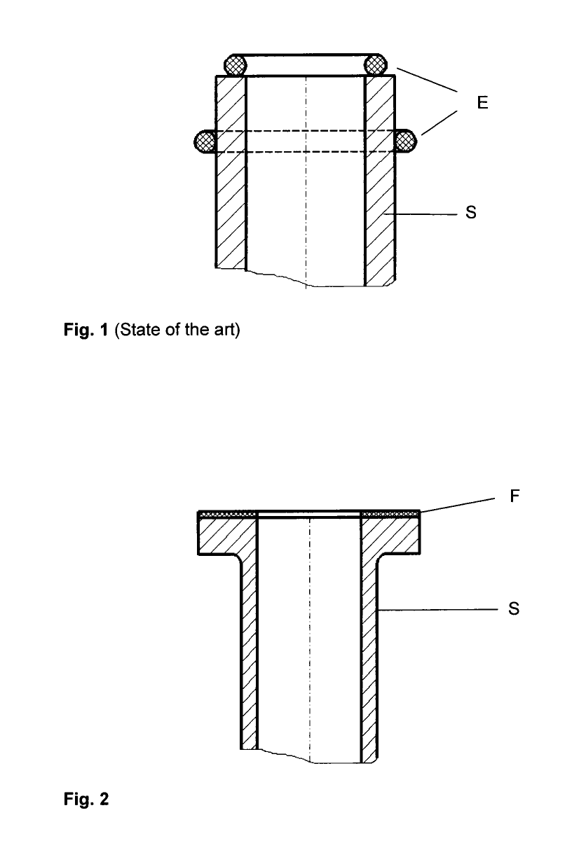

FIG. 1 shows a schematic of an xSiC tube (S) according to the prior art with an elastomeric gasket (E), which may be configured, for example, as an O-ring, in two different arrangements.

Because the thermal stability of elastomeric gaskets is limited to a range below about 250° C., the advantages of the xSiC material are not exploited in full.

It was thus an object of the present invention to enable a gasket design by means of non-elastomeric gaskets, which utilizes the stability of ceramic reactor tubes toward aggressive media at high temperatures, especially in processes for conversion of chlorosilanes.

This object is achieved by virtue of the xSiC tube described having a flange or a flare.

The invention accordingly provides for the use of an xSiC tube in the form of an elongated, cup-like shaped body in processes for conversion of chlorosilanes, wherein the xSiC tube has a flange or a flare at one end and is closed at the other end.

The advantage of the use is that there is no longer any need to use an elastomeric gasket. Instead, it is possible with preference to use flat gaskets.

The invention is illustrated in detail hereinafter.

The inventive use of the xSiC tube in processes for conversion of chlorosilanes is notable in that the xSiC tube has a flange or a flare at one end and is closed at the other end.

According to the invention, the xSiC tube can thus be used at much higher temperatures than is allowed by ceramic tubes with elastomeric gaskets according to the prior art, for example at temperatures of 550° C. or higher. The inventive use is likewise possible in the conversion of corrosive substances. The shaped body used in accordance with the invention preferably withstands an internal pressure of 0.2 to 50 bar gauge, preferably of 0.2 to 8 bar gauge.

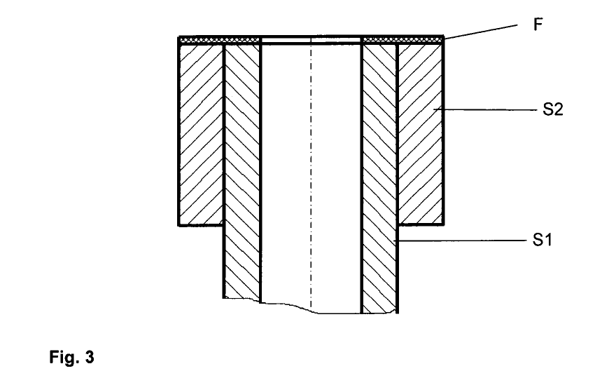

Possible configurations of the xSiC tube in the inventive use are shown in FIGS. 2 and 3. According to the invention, these configurations can be used with a gasket, preferably with a flat gasket. The use of the shaped body, provided with a flanged or flared end, with a flat gasket is particularly preferred. This enables use thereof at pressures of 0.2 to 50 bar gauge, more preferably at a pressure of about 6 bar gauge.

The reference symbols mean:
F flat gasket
S, S1, S2 shaped body at the flanged or flared end

The inventive use of such xSiC tubes enables the conversion of chlorosilanes, preferably the hydrogenation of chlorosilanes, further preferably the hydrogenation of tetrachlorosilane by means of hydrogen to trichlorosilane and HCl at 900° C. to 1100° C., in the presence of a catalyst or without a catalyst, preferably at pressures of 0.2 to 50 bar gauge, more preferably at a pressure of about 6 bar gauge.

FIG. 2 shows an xSiC tube used in accordance with the invention at its end configured as a flange. It may be advantageous to use this configuration with a flat gasket (F).

A further inventive use may consist in using, at the end of the xSiC tube configured as a flange, a flat gasket (F) consisting of graphite, mica and/or other materials of high thermal stability. The structure of such gaskets is known to those skilled in the art.

FIG. 3 shows a shape of the shaped body in which an xSiC tube (S1) is fitted or inserted into a further xSiC tube (S2), the end faces of S1 and S2 lying in one plane. Preferably, an xSiC tube is thus obtained with a mobile or immobile, more preferably immobile, flanged end. It may be advantageous to use this configuration with a flat gasket (F).

Further variants of the arrangement of components made of xSiC are possible in order to arrive at a flanged and/or flared configuration. These are described here in a non-comprehensive manner.

One inventive use of the xSiC tube consists in the conversion of chlorosilanes in furnace-heated tubular reactors for hydrogenation of chlorosilanes. In this case, the reaction region need not consist only of the elongated shaped body itself; instead, tube combinations inserted into one another are possible, the tubes of which are configured in the form of a flange or flare at one end.

1. A method for converting a chlorosilane, comprising:
converting the chlorosilane in an xSiC tube in a form of an elongated, cup-like shaped body,
wherein the xSiC tube has a flange or a flare at one end and is closed at the other end.

2. The method according to claim 1,
wherein the converting is carried out in a furnace-heated tubular reactor.

3. The method according to claim 1,
wherein the converting is carried out during a hydrogenation process.

4. The method according to claim 1,
wherein a flat gasket is present at an end of the xSiC tube configured as a flange and the flat gasket comprises graphite, mica and/or other materials of high thermal stability.

5. The method according to claim 3,
wherein the hydrogenation process is hydrogenation of tetrachlorosilane to trichlorosilane.

6. The method according to claim 3,
wherein the converting is carried out at a pressure of from 0.2 to 50 bar gauge and a temperature of from 900° C. to 1100° C.

7. The method according to claim 5,
wherein the converting takes place at a pressure of from 0.2 to 50 bar gauge and a temperature of from 900° C. to 1100° C.

8. The method according to claim 2,
wherein a flat gasket is present at an end of the xSiC tube configured as a flange and the flat gasket comprises graphite, mica and/or other materials of high thermal stability.

9. The method according to claim 3,
wherein a flat gasket is present at an end of the xSiC tube configured as a flange and the flat gasket comprises graphite, mica and/or other materials of high thermal stability.

10. The method according to claim 5,
wherein a flat gasket is present at an end of the xSiC tube configured as a flange and the flat gasket comprises graphite, mica and/or other materials of high thermal stability.

11. The method according to claim 6,
wherein a flat gasket is present at an end of the xSiC tube configured as a flange and the flat gasket comprises graphite, mica and/or other materials of high thermal stability.

12. The method according to claim 7,
wherein a flat gasket is present at an end of the xSiC tube configured as a flange and the flat gasket comprises graphite, mica and/or other materials of high thermal stability.
